(19) United States
(12) Patent Application Publication
(10) Pub. No.: US 2004/0190001 A1
(43) Pub. Date: Sep. 30, 2004

(54) Three dimensional imaging by projecting interference fringes and evaluating absolute phase mapping

(76) Inventors: Beverly Thomas Meggit, London (GB); John Howard Couper, Reading (GB); Shiping Chen, Fremont, CA (US)

Correspondence Address: BAKER & BOTTS, 30 ROCKEFELLER PLAZA, NEW YORK, NY, 10112

(21) Appl. No.: 10/486,397

(22) PCT Filed: Aug. 6, 2002
(86) PCT No.: PCT/GB02/03625

(30) Foreign Application Priority Data
Aug. 6, 2001 (GB) 0119036.2

(51) Int. Cl. G01B 9/02

(52) U.S. Cl. 356/512

(57) ABSTRACT

The invention relates to a method of calculating the three dimensional surface coordinates for a set of points on the surface of an object. The method comprises the following steps: using a projector for illuminating the object with a set of fringes, adjusting the fringes, capturing a plurality of images of the surface with a camera with different fringe phase settings, processing the images to produce an absolute fringe phase map of the parts of the surface which are both illuminated by the projector and visible to the camera, and processing the fringe phase map to give a set of coordinates for points on the surface of the object. The method provides surface profiling and ranging by using temporal phase measurement interferometry (TPMI) based on a modified Carré technique.

The present invention relates to a versatile 3D surface profiling and ranging system.

3D surface profiling and ranging systems are useful, for example in for on-line production control, product inspection, robot manufacturing arms, some medical applications where patients cannot be held still for long and measurement of large 3D surfaces.

There are three major types of 3D measurement technology, stereo imaging, laser scanning and fringe projection. Most of the stereo imaging systems work well only in a very specific situation with which its computer algorithm is designed to cope; a great deal of prior knowledge is required. Laser scanning has high precision but also has a high cost and low speed. The alternative is fringe projection which up until now has lacked ranging capability and good versatility and the ability to uniquely identify the fringe order and hence the absolute fringe phase across complex shaped targets with severely disconnected surface projections or on large 3D surfaces with smoothly curving profile without obvious surface features.

The operating distance of existing fringe projectors is not over 5 metres because of the effects of ambient light or/and the small (˜100 mW) output optical power from optical fibres. High power laser diodes are capable of delivering a CW power of up to 100 W and even higher in pulsed mode. Normally, such diodes cannot be used for interferometric applications because they are made of a multimode single stripe or an array of cavities resulting in poor spatial coherence.

We have now devised an improved 3D imaging system.

According to the invention there is provided a method of calculating the three dimensional surface coordinates for a set of points on the surface of an object which method comprises illuminating the object with a set of fringes, adjusting the fringes, capturing a plurality of images of the surface with a camera with different fringe phase settings, processing the images to produce an absolute fringe phase map of the parts of the surface which are both illuminated by the projector and visible to the camera, processing the fringe phase map to give a set of co-ordinates for points on the surface of the object.

The fringes can be produced by a range of techniques for example by the (Lloyd's) mirror technique described below, Fresnel bi-prism, Michelson interferometer etc. or fringes projected from a mask.

During the measurement process, the projector, object and camera remain stationary. The projector illuminates the object with a set of fringes within an illumination cone.

The fringes can be interference fringes and can be parallel or other known contour depending on their method of production. These fringes have an approximately equal or other known angular separation and can he adjusted in phase and spatial frequency by the system. The camera captures fringe images of the surface to be profiled. Adjustment of the fringes allows the capture of several images of the object with different fringe phase settings. The images can then be processed to produce a complete fringe phase map of the parts of the surface which are both illuminated by the projector and visible to the camera. The phase map can then be processed along with details of the system geometry to give a set of co-ordinates for each point on the surface of the object. A procedure for processing the data are described in the Phase analysis section below.

The fringe images can generate by the interference of two waves, one coming directly from a laser source (or from its image via a lens or refractory system) and one coming via a reflection or refraction from a mirror or other optical element(e.g. optical wedge) producing an image of the source. The resulting intensity at any point in the far-field depends on the phase difference between the two waves which depends on the physical path difference of the two waves and any additional phase shifts in the system.

The radiation can be of any part of the electromagnetic spectrum (gamma rays to radio waves) and can use any type of lasers, e.g. gas (Eximer, Argon Ion, HeNe, CO₂ etc.) or solid state laser e.g. laser diode, YAG or other laser source e.g. LED, Halogen lamp etc.

The invention can also be used with acoustic waves or any other types of wave motion (e.g. water waves).

The cameras can be of any type (analogue or digital) to match the source wavelength used (e.g. vidicon, CCD, pyroelectric, thermal imager etc.)

The adjustment of the fringes can be carried out in phase steps, most fringe analysis methods require a set of phase steps, each in the region of π/2. These steps can vary around π/2, covering a total range of perhaps π/6. Expressed in degrees this means limiting the phase steps to within the range 75 to 105°.

In order to achieve this, the most basic stepping regime of simply moving the interferometer mirror to change the difference in path length between the light coming directly from the source and the light coming form a reflection would be unsuitable because the steps are proportional to the fringe order at each point across the field. The reason is that if, for example, the high order fringe end of the field had a 105° step, then most of the field (about 70% of it below a step angle of 75° would be unusable. Even if the π/6 range was extended to say π/3, then 50% of the field would still be wasted. It would therefore be necessary either not to use a large part of the field, or to find a more efficient method of stepping the fringes to reduce the range of step size across the field. One method to achieve full usage of the field would be to use a mixed stepping method as follows:

(i) step all the fringes together by sweeping the projected field. This could be done by rotating, through a small angle, a second mirror situated after the interferometer. Alternatively, the whole projector could be rotated in a plane normal to the planes of the fringes. In either case, the resulting phase shift would be almost the same for all the fringes, since the fringe spacing is nearly constant across the field.

(ii) Additionally, step the interferometer mirror to add a small phase shift which varies proportionally to the fringe order across the field. This would vary from near zero at the low order fringes to a maximum of perhaps 7π/6 or π/3, depending on the image noise. Larger phase shifts can be used if the image noise is lower.

(iii) The total phase step size would then range between any chosen minimum and Maximum values.

This is clearly a complex method and we have devised an improved preferred method which is tolerant of a much wider range of phase step size.

We have calculated that

$$Δ d = \frac{5 π}{6} \frac{λ}{4 π Sin {δ}_{p}} = \frac{5 λ}{24 sin {δ}_{p}} \qquad Equation 1$$

Where Δd is the movement of the mirror, λ is the wavelength of the light, δₚ is the angle between the plane of the mirror and the direction to the point P from the mid point between the light source and the mirror

Therefore, if the maximum fringe order is say at an angle of 30° and the laser wavelength is for example 670 nm then the mirror movement for each phase step of 5π/6 at this angle would be: 0.28 μm per step.

If six frames are required, then five steps are needed, requiring a total movement of e.g. about 1.4 μm in this case.

If during system set-up, there is a need to scan the mirror until d=0 in order to calibrate the system and assess the values of d being used for the measurement, then the mirror stage must be capable of a movement greater than, at least, the operating value of d. In practice, the system should allow operation at longer wavelengths (e.g. 830 nm) and have the capability of operating with a larger number of fringes (possibly 30). The total movement then required, including a suitable margin would be perhaps 30 to 40 μm. This movement is well within the capability of commercially available translation stages.

The point by point analysis of a set of phase shifted frames can be carried out by a temporal phase measurement inteferometry (TPMI) method called the Carré technique and preferably a modified Carré technique is used.

In the basic Carré technique the phase step (α) and the wrapped phase value (Φ) at the point being measured are found as follows

$$α = 2 {Tan}^{- 1} [ {( \frac{3 ( {I}_{2} - {I}_{3} ) - ( {I}_{1} - {I}_{4} )}{( {I}_{2} - {I}_{3} ) + ( {I}_{1} - {I}_{4} )} )}^{\frac{1}{2}} ] \qquad Equation 2$$

and

Although the optimum value of the phase step (a) is close to π/2, determination of the phase step is stable (in a noise free system) over the whole range from α.>0 to α.>π.

The addition of π to the calculation of phase value ((φ) simply brings it within the range 0 to 2π rather than −π to +π

It should be noted, however, that when phase is calculated using just the equation above, the resulting phase values are correct only within the range π/2 to +3π/2. This is because for phase values outside this range, the calculated arctangent values repeat In order to obtain the correct phase value over the whole 2π range, it is necessary to identify which quadrant the calculated phase value is in. This can be done by finding the sign of the numerator and denominator of Equation 8. Using this information, corrections can be added to give continuous 2π ranges of phase values

In practice, the processing software has a built in function to extract the quadrant information and thus the full 2π range of phase values.

Although the basic Carré technique approach to phase and phase step calculation does give a correct analysis of the data for noise-free systems, there is a serious problem with data containing noise. The problem arises from the fact that at certain values of fringe phase (zero and π) the phase step becomes indeterminate. For real systems with noise, there is a significant range of fringe phase values close to these indeterminate points where the calculated phase step cannot be evaluated. This is not a problem for conventional applications, which only require knowledge of the fringe phase. It is fortunate for those applications that errors in the value of the phase step have very little effect on the calculated fringe phase precisely at the points close to phase values of zero and π.

An approach is therefore required which avoids indeterminate regions. One method would clearly be to take two (or more) sets of four frames in which the fringe phase values are different in such a way that at least one of them is not close to a fringe phase value of 0 or π. This is the basis of the approach taken, but the implementation is much more efficient than simply choosing the best set of four from those available.

If a set of five frames is acquired (say, numbered 1,2,3,4 & 5), they can be considered as two sets of four frames consisting of frames 1,2,3 & 4 and 2,3,4 & 5. It turns out, that, for the range of phase steps which can be used, at least one of the sets of 4 frames must give an unambiguous value of phase step for any value of fringe phase.

Similarly, a set of six frames can be considered as three sets of four frames. This approach can, of course be extended to any number of frames, but six has been chosen here because it gives good results without adding excessively to the computational requirements and the stability requirements of the optical system.

The most important part of the calculation is the method of combining the information from the evaluation of phase step. For this calculation, the six frames have been treated as three sets of four, but if the step value is fully evaluated for each group of four as in Equation 2,

$$α = 2 {Tan}^{- 1} [ {( \frac{3 ( {I}_{2} - {I}_{3} ) - ( {I}_{1} - {I}_{4} )}{( {I}_{2} - {I}_{3} ) + ( {I}_{1} - {I}_{4} )} )}^{\frac{1}{2}} ] \qquad Equation 2$$

the results need to be evaluated subsequently to assess which are acceptable and the whole process becomes rather messy.

The problem arises from the fact that the origin of the ambiguity is in the ratio—

$$\frac{3 ( {I}_{2} - {I}_{3} ) - ( {I}_{1} - {I}_{4} )}{( {I}_{2} - {I}_{3} ) + ( {I}_{1} - {I}_{4} )}$$

within Equation 2.

Near to fringe phase values of 0 or π, the numerator and denominator of this ratio both approach zero and thus become very susceptible to noise. A method was therefore sought which could combine the ratios from the three sets of four frames without encountering any ambiguous regions. If the three sets of four frames are labeled a, b and c, then the relevant ratios can be represented as:

$$\frac{{A}_{a}}{{B}_{a}} , \frac{{A}_{b}}{{B}_{b}} and \frac{{A}_{c}}{{B}_{c}} .$$

Since the phase step size is the same at a given point for each set of four frames, it follows that they are also equal to the combined ratio

$$\frac{{A}_{a} + {A}_{b} + {A}_{c}}{{B}_{a} + {B}_{b} + {B}_{c}} .$$

If the combined ratio is calculated as shown, the ambiguous regions simply shift to different values of fringe phase. This is because the values of A and B can he positive or negative and their sums can be zero. However, it should be noted that for this application, the ratios for sets a, b and c are either all positive or all negative (because the phase step is the same for each set). Therefore, for positive phase steps (>0 and <π), A and B are either both positive or both negative and thus the combined ratio is unchanged if the signs of any A and B pair are both changed. The consequence of this is that the result is unaffected if the modulus of each of the values of A and B is used in the combined ratio as follows:

$$\frac{\vert {A}_{a} \vert + \vert {A}_{b} \vert + \vert {A}_{c} \vert}{\vert {B}_{a} \vert + \vert {B}_{b} \vert + \vert {B}_{c} \vert} \qquad Equation 3$$

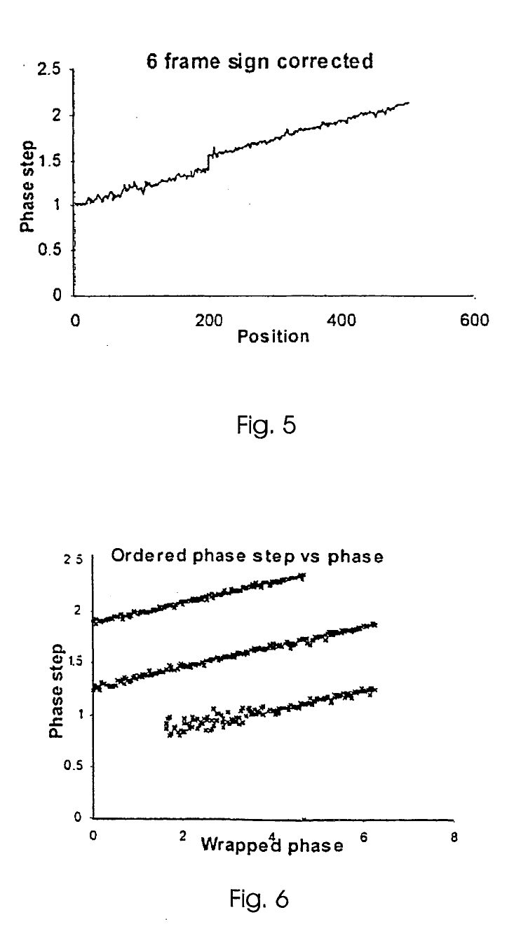

The denominator of the ratio in Equation 3 only approaches zero if either the fringe contrast or the phase step approach zero. Both these conditions are avoided. The effect this has on the phase step calculation can be seen in the following plots calculated from one line of a set of real image data as shown in FIGS. 4 and 5.

The calculations for FIG. 4 and FIG. 5 use data from the same set of frames, which span approximately 4.5 fringes and have a phase step which increases across the image. The calculations result in 9 ambiguous regions in the plot in FIG. 4 and none in FIG. 5. The discontinuity, which corresponds to a physical step in the target object can be seen clearly in FIG. 5 and, in this case, represents a change in absolute phase of about a third of a fringe order.

Thus, the six-frame equation for phase step calculation is:

$$α = 2 {Tan}^{- 1} [ {( \frac{\vert {A}_{a} \vert + \vert {A}_{b} \vert + \vert {A}_{c} \vert}{\vert {B}_{a} \vert + \vert {B}_{b} \vert + \vert {B}_{c} \vert} )}^{\frac{1}{2}} ] \qquad Equation 4$$

Where:

Aₐ=3(I₂−I₃)−(I₁−I₄)

Bₐ=(I₂−I₃)+(I₁−I₄)

Aₐ=3(I₃−I₄)−(I₂−I₅)

B_{b}=(I₃−I₄)+(I₂ −I₅)

A_{c}=3(I₄−I₅)−(I₃−I₆)

B_{c}=(I₄−I₅)+(I₃−I₆)

and I₁ to I₆ are the intensities pf the image point in the six frames.

Now that the phase step size can be determined without ambiguity, we can turn our attention to tile fringe phase value. Fortunately, fringe phase calculation causes fewer problems than the step calculation. In fact, the original formula in Equation 3 can be used with intensities I₂, I₃, I₄ and I₅ along with the six-frame value for phase step from Equation 4. Although this gives useable results, it does not make use of all six frames of data available. The following six-frame equation gives marginally better results for the fringe phase value:

$$φ = {Tan}^{- 1} [ \frac{- {I}_{1} - {I}_{2} + 2 {I}_{3} + 2 {I}_{4} - {I}_{5} - {I}_{6}}{2 ( - {I}_{2} - {I}_{3} + {I}_{4} + {I}_{5} )} ] + π \qquad Equation 5$$

Calculation of the Absolute Phase Value

The principal is that the preferred design of the projector ensures that the phase step size is proportional to the absolute fringe phase. For each image point, we calculate two values. These are the phase step size and the wrapped fringe phase (a repeating 0 to 2π range of φ). In order to calculate the absolute phase of the fringe at this point, we need to know the constant of proportionality S relating these two values:

$$S = \frac{Φ}{α} \qquad Equation 6$$

In the simplest approach, the phase step could be used to calculate an approximate value of absolute fringe phase as follows: Φ=S*a. Values obtained this way do not need a separate calculation of fringe phase at all, but they have a much greater local uncertainty (due to noise) than the wrapped phase values. The wrapped phase values of course have the uncertainty of unknown fringe order n (fringe phase error=2nπ, since the absolute fringe phase Φ=2nπ+φ.

The approximate value of Φ can be compared with the wrapped phase value (φ) and adjusted to give the final absolute phase. This is simply a matter of choosing the value of n giving the best match between the approximate value of Φ=sα and the more precise value of Φ=2nπ+φ. This approach is used in the analysis software and works provided that the error in the calculated phase step value corresponds to an absolute phase error of less than π, so that the fringe order can be identified correctly.

Of course, the parameter S must be found before the data can be analysed. This could be measured directly by measuring phase steps for known fringe orders in a separate calibration process. The precision of calibration would then rely on the continuing stability of the optical system. However, any set of six images of an object already contains all the information necessary for calibrating the parameter S for each measurement.

S can be found as follows: some or all of the datapoints in the image can be used for calibration. The procedure compares each calculated phase step values with the corresponding calculated wrapped phase value. If these pairs of values are plotted against each other, then the result is a plot similar to FIG. 6.

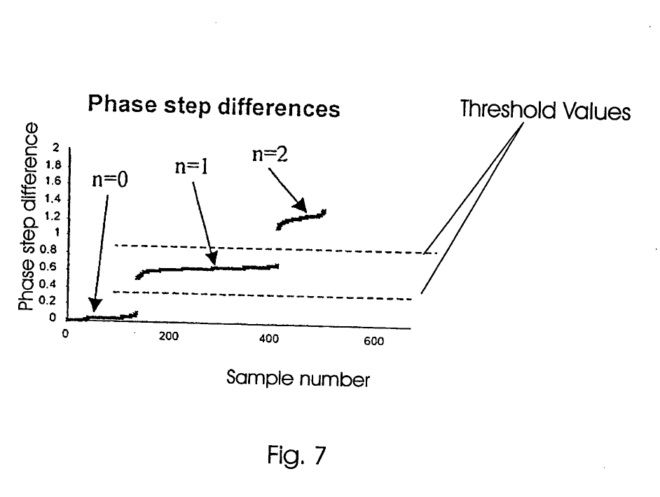

The plot consists of a set of dislocated line segments. The plot for any given image may have some parts of the characteristic missing, depending on the surface profile of the object, but this does not affect the analysis provided there are contributions from several different fringe orders. Finding S is then a matter of determining the mean phase step difference between adjacent line segments. This is done by calculating the difference between the measured phase step of two points having similar wrapped phase values. The pair of points will represent two absolute phase values with an absolute phase difference close to 2π (since wrapped phase values are very similar). Where n=0, 1, 2, 3. When a set of these difference values is sampled and plotted (say in ascending order), a graph similar to FIG. 7 will result.

The value of phase step differences representing (say) n=1 can then be found by selecting a pair of threshold values for the upper and lower limits of the band. The mean values of the points within the selected band can then be calculated. For a given system, the threshold values can be fixed and S can be found provided that the appropriate step difference values remain within the threshold limits. If the value of a representing n=1 is α₁, and given that the absolute phase difference between adjacent orders is 2π, then the value of S from Equation 6 is given by

$$S = \frac{2 π}{{α}_{1}}$$

Selection of Operating Parameters

As described above, the calculation of the absolute phase (Φ) requires that the phase step a must be determined with sufficient accuracy to identify the order of the fringe containing the point being measured. Selection of the parameters governing the evaluation of Φ must be made carefully in order to optimise the precision of phase measurement while reducing the probability of misidentifying the fringe order to an acceptable level. The range of uncertainty in phase step size at any point must be less than a threshold value representing the difference of phase step between one fringe order and the next. This uncertainty depends largely on the number of fringes across the image and the range of phase step size, as indicated below.

Requirements to optimise precision of phase measurement:

Maximise the number of fringes across the projected field.

Minimise the range of phase step size to values close to the lowest noise sensitivity value.

Minimise the image noise

Requirements to minimise the probability of misidentifying the fringe order

Minimise the number of fringes across the projected field.

Maximise the range of phase step size.

Minimise the image noise

We must therefore minimise image noise and determine the optimum compromise of the other two parameters.

Surface Shape Calculation

The surface phase map gives an absolute fringe phase value for each pixel of the image plane. This is not a map of the surface co-ordinates. The 3-dimensional coordinates of the point imaged by each pixel can now be found using both the calculated phase values and the geometry of the optical system.

A description of the geometry of an optical system of an embodiment of the invention and the calculations required to produce the map of surface co-ordinates are illustrated in the accompanying drawings in which

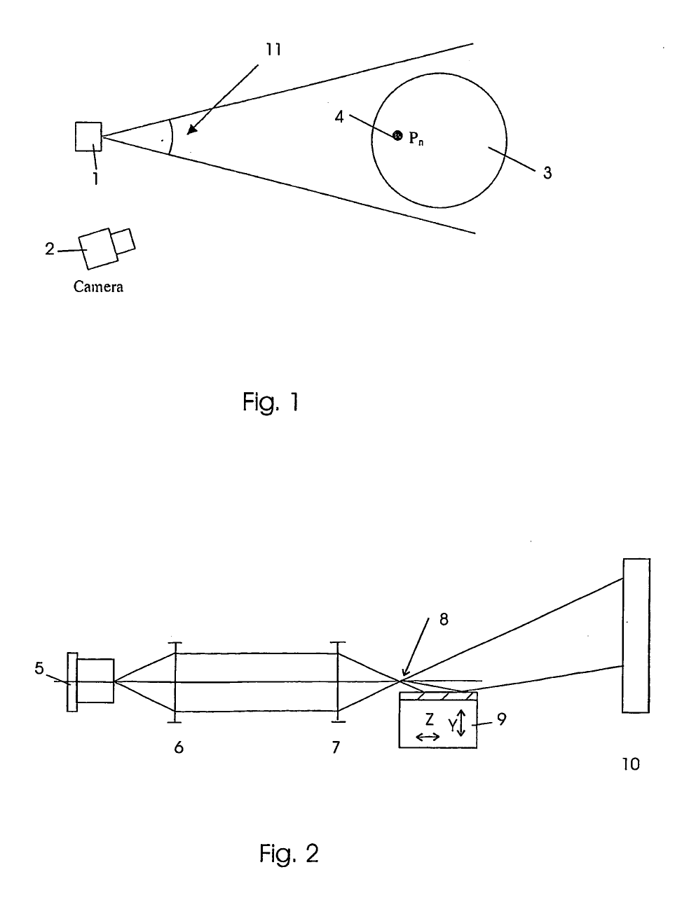

FIG. 1 shows a profiling system

FIG. 2 shows a projector layout

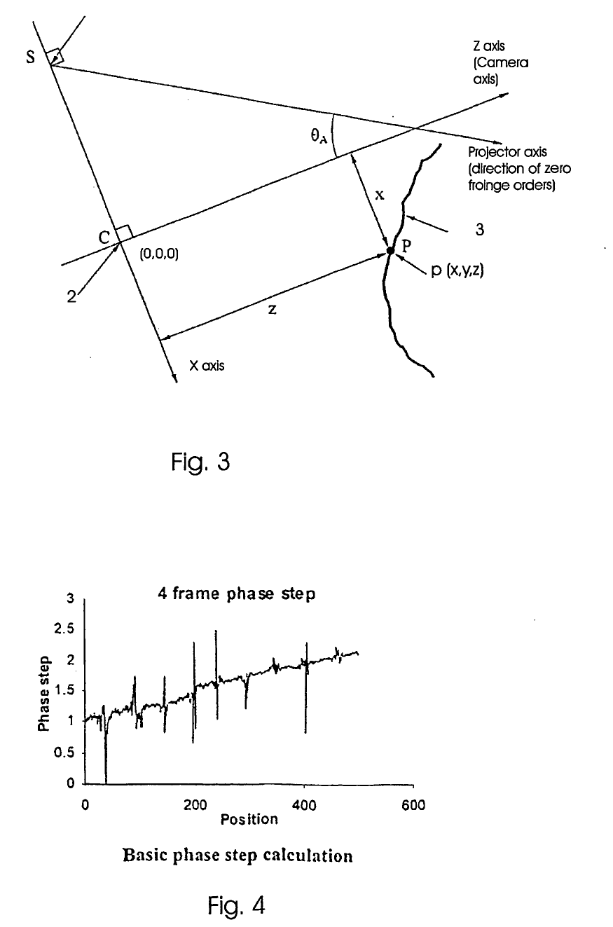

FIG. 3 shows a plan view of the system

FIGS. 4, 5, 6 and 7 are referred to above

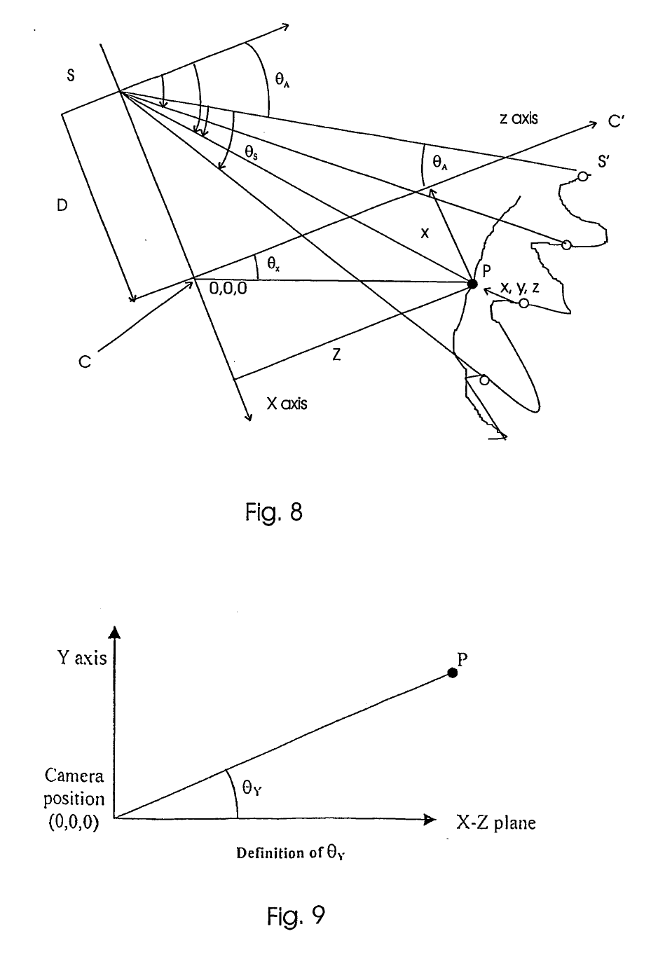

FIG. 8 represents a phase layout for the plane Y=0

FIG. 9 shows the calculation of the coordinates

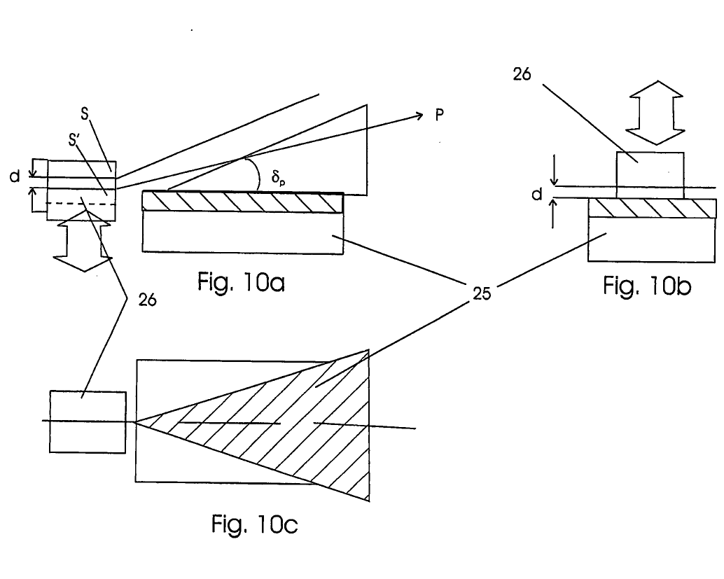

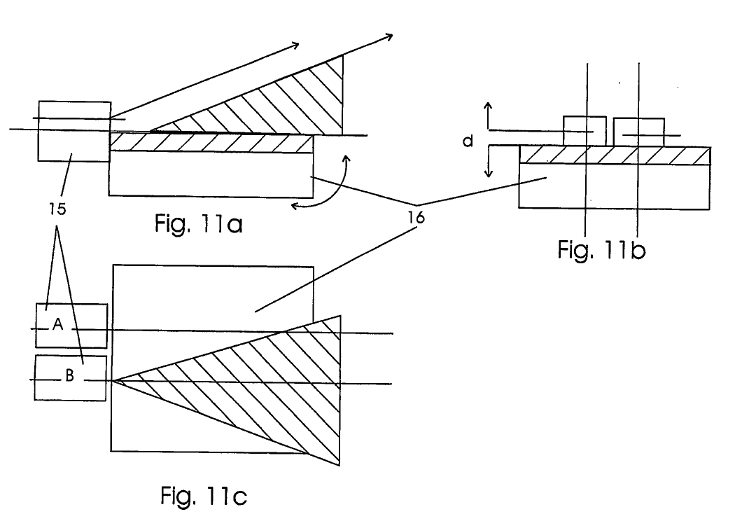

FIG. 10 shows one arrangement and

FIG. 11 shows an alternative arrangement.

Referring to FIGS. 1 and 3 in the basic set up to find the coordinates of point (P) on object (3) a projector (1) at position S projects fringes onto the object (3) and a camera (2) at position (C) (FIG. 3) takes images of the object. Referring to FIG. 3 the x axis is the line between the projector at position S and camera at position (C), the z axis is the camera axis and the y axis is perpendicular to these axes.

A projector is shown in FIG. 2 in which the object under illumination is shown at (10); the light from laser (5) passes through lenses (6) and (7) to project laser stripe (8) onto mirror on Y-Z stages (9) so that two beams of light, one direct from the laser and one via the mirror are projected on to the image to form interference fringes. By moving the mirror in steps by moving the stage (9) the phase difference between the two beams of light and hence the fringes can be adjusted.

If the calculation of surface co-ordinates is to be reasonably straightforward, then the choice of coordinate system must be considered carefully. The basic system layout and orientation is as described above in FIGS. 1 and 3.

FIG. 8 shows the chosen X and Z axes and the relevant system dimensions and angles. The Y axis is normal to the plane of the diagram.

FIG. 8 represents the layout for tile plane Y=0. However, since the fringes are ‘vertical’—i.e. constant in Y, the angles θ_{A}, θ_{S} and θ_{X} are also independent of the Y co-ordinate of point P. The X and Z co-ordinates of point P can therefore be calculated for any Y, followed by calculation of the Y co-ordinate.

In the diagram above, SS′ is the axis of the source (the projector), this is the direction corresponding to the zero order fringe. Since all the projected fringes are on one side of the projector axis, all values of θ_{S} are positive. The angle θ_{S} is found from the absolute phase Φ and the angular separation of the fringes as described below.

CC′ is the camera axis and coincides with the z axis of the coordinate system. θ_{X} takes both positive and negative values.

The camera and projector are separated by a distance D along the x axis.

Calculation of the Co-Ordinates

This section describes how the x,y and z co-ordinates of point P are found from the input parameters.

From FIG. 8 it can be seen that, looking from the camera (C),

x=z. Tan(θₓ) Equation 7

Looking from projector (S),

$$\begin{matrix}z = \frac{x + D}{Tan ( {θ}_{S} + {θ}_{A} )} & Equation 8 \\ z = \frac{x + D}{Tan ( {θ}_{S} + {θ}_{A} )} & Equation 9\end{matrix}$$

The x and z co-ordinates can then be expressed in terms of tile input parameters as follows.

$$z = \frac{z . Tan ( {θ}_{X} )}{Tan ( {θ}_{S} + {θ}_{A} )} + \frac{D}{Tan ( {θ}_{S} + {θ}_{A} )} \\ ∴ z ( 1 - \frac{Tan ( {θ}_{X} )}{Tan ( {θ}_{S} + {θ}_{A} )} ) = \frac{D}{Tan ( {θ}_{S} + {θ}_{A} )} \\ ∴ z = \frac{D}{( 1 - \frac{Tan ( {θ}_{X} )}{Tan ( {θ}_{S} + {θ}_{A} )} ) Tan ( {θ}_{S} + {θ}_{A} )} \\ ∴ z = \frac{D}{( Tan ( {θ}_{S} + {θ}_{A} ) - Tan ( {θ}_{X} ) )} \qquad Equation 10$$

x can now be found directly' from Equation 7:

x=z. Tan(θ_{X})

Finally, the y co-ordinate can be expressed as:

y=(\sqrt{x²+z²}). Tan(θ_{y})

Where θ_{Y} is defined as the angle between the x-z plane and tile direction from the camera to the object point P as shown in FIG. 9.

The angles θ_{X} and θ_{Y} are related to the pixel positions of the image as follows:

It is assumed that the system has been aligned such that the central pixel of the image plane corresponds to a view along the z axis. If the camera has Nₓ pixels in each row, the columns are numbered

$$- ( \frac{{N}_{x}}{2} ) , - ( \frac{{N}_{x}}{2} - 1 ) … 0 … \frac{{N}_{x}}{2}$$

The pixel position corresponds to a view at an angle θ_{X} from the z axis . If the pixel separation is w and the camera lens has a focal length v then θ_{X} for pixel number nₓ is

$${θ}_{X} = {Tan}^{- 1} ( \frac{{n}_{x} w}{v} )$$

Similarly, if the camera has N_{Y} pixels in each column then θ_{y} for pixel number n_{y} is

$${θ}_{Y} = {Tan}^{- 1} ( \frac{{n}_{y} w}{v} )$$

The angle θ_{S} for point P is related to the absolute fringe phase Φ. From Equation 1: is

Φ=C*Sin(θₛ)

where C is a constant.

The value of C is obtained from a separate calibration procedure in which the fringe order (and thus Φ) is measured for one angle θ_{S}. Of course, the actual value of C changes as the fringes are scanned. It is therefore important to calibrate the system with the fringes set to the mean position of the set of frames. This mean position is the same as that resulting from the phase calculations.

The angle θ_{A} is set directly by the alignment of the system. It is essential for a valid analysis that the projector at S lies on the x axis as defined by the camera orientation.

Referring to FIG. 10, 10a is front view, 10b is a side view and 10c is a top view the fringe projector consists of a laser diode (26), a mirror (25) and a piezoelectric actuator to adjust d, the separation between the laser cavity and the minor surface. The projected fringe pattern can be regarded as the far-field Young's interference fringes formed by the laser cavity, S, and its image in the mirror S′. Here, the optical path difference between PS and PS′ equals to 2d sin δₚ. where δₚ is the angle between the direction of the mirror surface and that of the line linking P and the projector. The “global” phase difference at P, Φₚ, between the light initiated from S and S′ is given by

$${Φ}_{p} = \frac{2 π}{λ} 2 d sin {δ}_{p} = 4 πsin {δ}_{p} \frac{d}{λ} \qquad Equation 11$$

where λ is the wavelength of the projected light. If the local phase at P, i.e. the value of Φₚ within 0-2π ambiguity range, is presented as φₚ thus

Φₚ=φₚ+2Nπ Equation 12

where N is the order of the interference fringe at P. There are a number of established schemes called temporal phase-measurement interferometry (TPMI)(19) capable of measuring φₚ in which a controlled phase steps, αₚⱼ are added to Φₚ and the corresponding interferogram intensities at point P for each step are recorded as

Iₚⱼ=Aₚ+Bₚ cos(Φₚ+αₚⱼ) Equation 13

where the subscript j represents the sequence number of the phasesteps. The Carré technique in particular requires four equal steps of α_{p,1.2,3,4}=−3/2 αₚ, −1/2 αₚ, 1/2 αₚ, 3/2 αₚ to be introduced. This gives

$${φ}_{p} = {tan}^{- 1} [ tan ( \frac{{α}_{p}}{2} ) \frac{( {I}_{p1} - {I}_{p4} ) + ( {I}_{p2} - {I}_{p3} )}{( {I}_{p2} + {I}_{p3} ) - ( {I}_{p1} + {I}_{p4} )} ] + π \\ {α}_{p} = 2 {tan}^{- 1} ( \sqrt{\frac{3 ( {I}_{p2} - {I}_{p3} ) - ( {I}_{p1} - {I}_{p4} )}{( {I}_{p1} - {I}_{p4} ) + ( {I}_{p1} - {I}_{p3} )}} ) \qquad Equation 14$$

In conventional systems, the phase step, αₚ, is the same across the whole projected beam. However, since the algorithm itself does not require such an uniformity, αₚ is used to identify the interference order of the fringe at P in the proposed system. Here. phase stepping Is achieved by changing d in equal steps of Δd, to produce a phase step

$${α}_{p} = 4 πsin {δ}_{p} \frac{Δ d}{λ} = {Φ}_{p} \frac{Δ d}{d} \qquad Equation 15$$

according to Equation 11. The combination of Equations 15 and 14 gives a rough estimation of Φₚ from which the interference order of the fringe can be calculated as

$$N = trunc ( \frac{{α}_{p} d}{2 πΔ d} ) \qquad Equation 16$$

where trunc( ) stands for truncating to integer. Bringing Equations 15 and 14 into 12, a much more accurate measure of Φₚ, can be obtained, With the absolute, global Φₚ the exact position of P in 3D space can be Identified without ambiguity. Furthermore, it can be seen from Equation 14 that |αₚ|<π and it is known that sin δₚ<sin θ Applying these conditions to Equation 15. The displacement of the mirror at each step can be estimated as

$$\vert Δ d \vert < \frac{λ}{4 π sin θ} \qquad Equation 16$$

which is well within the range of piezo-electric actuators.

Referring to FIG. 11 this shows an alternative arrangement for the fringe projector and 11a is front view, 11b is a side view and 11c is a top view. Here two laser diodes (15) are permanently fixed side-by-side on the mirror (16). The quotient, d/λ of the two is designed so that the global phases associated with the two lasers are slightly different at the same point, P, on the object surface, which can be expressed as:

$$Δ {Φ}_{p} = {Φ}_{p A} - {Φ}_{p B} = 4 π sin {δ}_{p} ( \frac{{d}_{A}}{{λ}_{A}} - \frac{{d}_{B}}{{λ}_{B}} ) \qquad Equation 17$$

Now, by switching on lasers A and B, one at a time, the associated local phase φ_{pA} and φ_{pB} can be obtained using the more mature Three-Frame technique . This can be expressed as:

$$\begin{matrix}{φ}_{p A} = {tan}^{- 1} ( \frac{{I}_{A3} - {I}_{A2}}{{I}_{A1} - {I}_{A3}} ) \\ {φ}_{p B} = {tan}^{- 1} ( \frac{{I}_{B3} - {I}_{B2}}{{I}_{B1} - {I}_{B2}} )\end{matrix} \qquad Equation 18$$

Here, phase stepping can be achieved by introducing a series of controlled small tilts to the mirror-laser assembly, the fringe order can be calculated as:

$$N = trunc [ \frac{{φ}_{p A} - {φ}_{p B}}{2 π ( 1 - {λ}_{A} {d}_{B} / {λ}_{B} {d}_{A} )} ] \qquad Equation 19$$

Similarly, by bringing Equations (12) and (9) into (2), a much more accurate measure of the global phase Φₚ (in this case Φ_{pA}) be obtained.

Although this alternative arrangement requires a slightly longer image acquisition time (a total of 6 frames versus 4 in previous scheme), It has the advantage of much faster data processing, since the phase retrieval algorithm is simpler and much more mature in comparison with Carré technique, thus resulting in a higher accuracy and possibly a shorter 3D profiling cycle. In addition, the whole diode-mirror assembly can be fabricated on a single substrate in volume production, which will further enhance projector robustness, improve fringe quality and reduce the cast and size. The common feature of the two arrangements described above is that laser diodes, especially high power ones, are used as optical sources. These diodes can produce up to 100 W optical power in pulse mode, which can be easily adjusted over a very wide range depending on the distance and size of the object to be measured. Such diodes cannot normally be used for interferometer applications, because they are made of an array of cavities, resulting in poor spatial coherence. This will not be a problem in the proposed projector as long as the cavity array is aligned parallel to the mirror surface. At a typical spectral line-width of 12 nm, these diodes also have a very short temporal coherence length (approx 70 nm). With the unique configuration of the proposed projector, such a short coherence length is not only sufficient to produce enough quality interference fringes, but also brings in an additional benefit of specific suppression for the system. The structural simplicity of both configurations also helps to improve the stability of the fringe pattern, which is important to the measurement precision of the system.

In addition, laser diodes are very efficient devices. As depicted in FIG. 1, a band pass interference filter that matches the line width of the laser diode Is installed at the camera aperture. It is estimated that the fitter, together with synchronised Laser pulse anti camera shutter can improve the system's immunity to ambient light by at least 600 fold. A 100 W pulsed diode is therefore, equivalent to a 60 KW bulb in a normal white-light slide projector. Because the output beam of the projector is highly divergent, such a power level can still be within safe limit of human vision at designed operating distance. Safety can be further improved through careful selection of wavelength and pulse width.

1. A method of calculating three dimensional surface coordinates for a set of points on the surface of an object, the method comprising:
illuminating the object with a set of fringes,
adjusting the fringes,
capturing a plurality of images of the surface with a camera with different fringe phase settings,
processing the images to produce an absolute fringe phase map of parts of the surface which are both illuminated by the projector and visible to the camera,
processing the fringe phase map to give a set of co-ordinates for points on the surface of the object.

2. The method of claim 1 in which the fringes are interference fringes.

3. The method of claim 2 in which the fringes have an approximately equal angular or other known separation and are adjustable in phase and spatial frequency and the camera captures several images of the object with different fringe phase settings.

4. The method of claim 3 in which the fringes are generated by the interference of two waves, one coming directly from a laser source or from its image via a lens or refractory system and one coming via a reflection or refraction from an interferometer mirror producing an image of the source.

5. The method of claim 4 in which the adjustment of the fringes is carried out in phase steps by sweeping the projected field and stepping the interferometer mirror to add a small phase shift which varies as a function of the fringe order across the field.

6. The method of claim 5 which the phase step size is related to the absolute fringe phase.

7. The method of claim 6 in which the distance of the steps in the stepping of the mirror is calculated according to equation 1 herein.

8. The method of claim 7 in which the mirror is stepped in five steps to produce six frames.

9. The method of claim 8 in which two (or more) sets of four frames are taken in which the fringe phase values are different in such a way that at least one of them is not close to a fringe phase value of 0 or π.

10. The method of claim 9 in which a set of at least five frames is acquired and are treated as a plurality of sets of four frames.

11. The method of claim 4 in which a set of five frames is acquired numbered 1, 2, 3, 4 & 5, and are considered as two sets of four frames consisting of frames 1, 2, 3 & 4 and 2, 3, 4 & 5.

12. The method of claim 4 in which a set of at least six frames is acquired and treated as sets of four frames.

13. The method of claim 4 in which a set of at least six frames is acquired and treated as three sets of four frames.
